(19) United States
(12) Patent Application Publication
(10) Pub. No.: US 2007/0097045 A1
(43) Pub. Date: May 3, 2007

(54) Display apparatus having LED backlight and brightness adjusting method for the same

(75) Inventors: Sang-hoon Lee, Nam-gu (KR); Yung-jun Park, Yongin-si (KR); Jeong-il Kang, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/517,506

(22) Filed: Sep. 8, 2006

(30) Foreign Application Priority Data
Oct. 28, 2005 (KR) 2005-0102337

(51) Int. Cl. G09G 3/32

(52) U.S. Cl. 345/82

(57) ABSTRACT

A display apparatus including a backlight with an LED and a brightness adjusting method which is capable of accomplishing uniform brightness across the entire display screen are provided. A display apparatus comprising a backlight comprising a plurality of LEDs and a plurality of current supplying parts respectively supplying a driving current to the LEDs, comprises a light sensor receiving light generated from the LEDs, and a controlling part controlling the current supplying parts to selectively drive the LEDs, and adjusting the amount of the driving current of the current supplying parts to be supplied to the driven LED so that the intensity of light received to the light sensor corresponds to a predetermined reference value.

### CROSS-REFERENCE TO RELATED APPLICATIONS

This application claims the benefit under 35 U.S.C. §119(a) of a Korean Patent Application No. 2005-0102337, filed on Oct. 28, 2005, in the Korean Intellectual Property Office, the entire disclosure of which is hereby incorporated by reference.

### BACKGROUND OF INVENTION

1. Field of Invention

The present invention relates to a display apparatus and a brightness adjusting method. More particularly, the present invention relates to a display apparatus including a backlight comprising an LED and a brightness adjusting method allowing the backlight to have a uniform light output distribution with a predetermined reference value.

2. Description of the Related Art

Generally, a display apparatus such as an LCD apparatus requires a separate lighting means due to non-luminescence of an image forming unit such as an LCD panel. The lighting means is typically provided on a rear side of the LCD panel as a backlight. The backlight emits light toward the LCD panel and forms an image in a front screen of the LCD apparatus. Conventionally, an incandescent electric lamp and a fluorescent lamp, among others have been used as the lighting means. However, these lamps experience problems such as low energy efficiency and overheating, among others. Therefore, an LED (light emitting diode) array has recently been developed as the lighting means.

FIG. 1 is a circuit diagram schematically illustrating a configuration of a backlight 10 comprising an LED array. As shown in FIG. 1, a plurality of LEDs 11 are arrayed on a plane, and each LED 11 includes a current supplying part 12 respectively. Each current supplying part 12 receives a control signal from a controlling part (not shown) independently and drives the corresponding LED 11. The LEDs 11 emit light to transmit an LCD panel (not shown) provided on the front thereof.

However, in the conventional display apparatus including the backlight 10 comprising the LED array, since the current supplying parts 12 are independently provided to drive the respective LEDs 11, the light output distribution of the backlight 10 may not be uniform by means of the different attributes of the current supplying parts 12 and the LEDs 11, though the same control signals are input to all the current supplying parts 12.

Consequently, it is difficult for the display apparatus to accomplish uniform brightness across the entire display screen.

Accordingly, there is a need for an improved brightness adjusting method and a display apparatus comprising a backlight comprising an LED capable of accomplishing uniform brightness.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a display apparatus including a backlight comprising an LED and a brightness adjusting method capable of accomplishing uniform brightness across the entire display screen.

Exemplary embodiments of the present invention can be achieved by providing a display apparatus comprising a backlight, a plurality of LEDs and a plurality of current supplying parts. A driving current is respectively supplied to the LEDs by the plurality of current supplying parts. A light sensor receives light generated from the LEDs and a controlling part controls the current supplying parts to selectively drive the LEDs, and adjusts the amount of the driving current of the current supplying parts to be supplied to the driven LED so that the intensity of light received by the light sensor corresponds to a predetermined reference value.

According to an aspect of an exemplary embodiment of the present invention, the display apparatus further comprises a plurality of light transmitting parts transmitting light generated from each LED to the light sensor, wherein the LEDs are controlled by the controlling part to respectively supply the light to the corresponding light transmitting part.

According to an aspect of an exemplary embodiment of the present invention, the controlling part selects one of the LEDs, and sets the intensity of the light generated from the selected LED as the reference value.

According to an aspect of an exemplary embodiment of the present invention, the display apparatus further comprises a storing part for storing information about the amount of the driving current of the current supplying parts to be supplied to each LED.

To achieve other aspects of an exemplary embodiment of the present invention, a display apparatus is provided. The display apparatus comprises a backlight, a plurality of LEDs and a plurality of current supplying parts respectively supply a driving current to the LEDs. A storing part stores information about the amount of the driving current to be supplied to the LED so that the intensity of light generated from the LEDs corresponds to a predetermined reference value and a controlling part controls the amount of the driving current of the current supplying parts based on the information stored in the storing part.

According to an aspect of an exemplary embodiment of the present invention, a brightness adjusting method for a display apparatus comprising a backlight with a plurality of LEDs is provided. A plurality of current supplying parts supply a driving current to the LEDs, respectively. A predetermined reference value is set for the intensity of light, light generated from the LEDs is received and selectively driven by controlling the current supplying parts, and the amount of the driving current of the current supplying parts is adjusted so that the intensity of the received light corresponds to the reference value.

According to another aspect of an exemplary embodiment of the present invention, the reference value setting stage comprises selecting one of the LEDs, and setting the intensity of light generated from the selected LED as the reference value.

According to an aspect of an exemplary embodiment of the present invention, the brightness adjusting method further comprises storing information about the amount of the driving current of the current supplying parts to be supplied to each LED.

According to an aspect of an exemplary embodiment of the present invention, a brightness performing method for a display apparatus comprising a backlight with a plurality of LEDs is provided. A plurality of current supplying parts supply a driving current to the LEDs, respectively. Information about the amount of the driving current to be supplied to each LED is provided so that the intensity of light generated from the LEDs corresponds to a predetermined reference value and the amount of the driving current of the current supplying parts is adjusted based on the provided information.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features, and advantages of certain exemplary embodiments of the prevent invention will be apparent from the following description taken in conjunction with the accompany drawings, in which:

FIG. 1 is a circuit diagram of a backlight according to a conventional display apparatus;

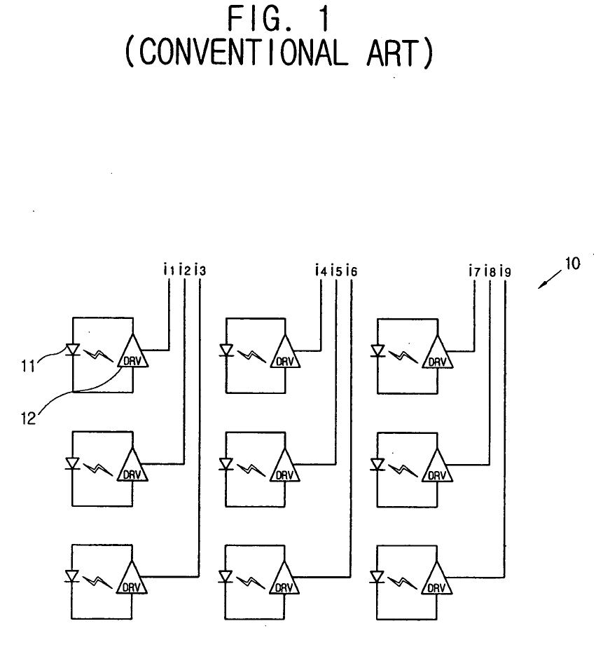

FIG. 2 is a circuit diagram schematically illustrating a display apparatus according to an exemplary embodiment of the present invention;

FIG. 3 is a flowchart illustrating a brightness adjusting method for a display apparatus according to an exemplary embodiment of the present invention; and

FIG. 4 is a flowchart illustrating a method for accomplishing a uniform brightness distribution in a display apparatus according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

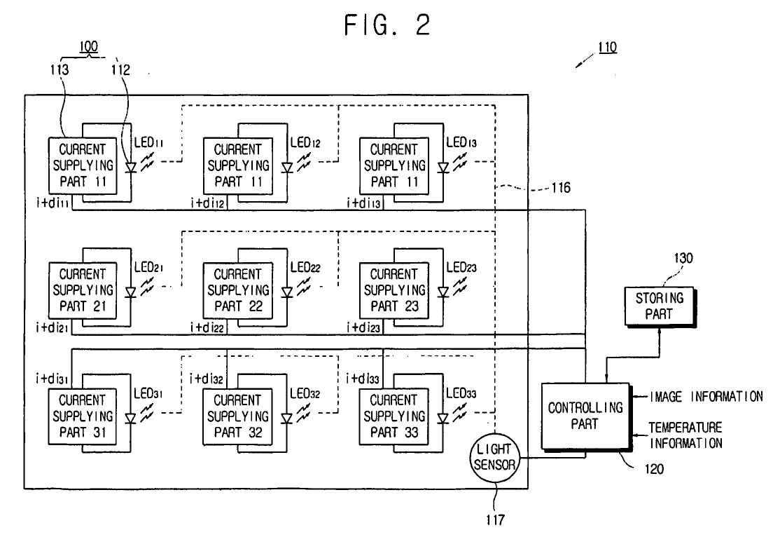

As shown in FIG. 2, a backlight 110 includes LEDs 112 arranged in a 3 by 3 configuration on a plane. Alternatively, the backlight 110 may include LEDs 112 with other arrangements.

A display apparatus 100 may include the backlight 110, a light leading tube 116, a light sensor 117, a controlling part 120, and a storing part 130 provided to control the backlight 110.

The backlight 110 includes the plurality of LEDs 112 arranged on a plane, and a plurality of current supplying parts 113 corresponding to the respective LEDs 112.

The respective current supplying parts 113 are electrically connected with the controlling part 120, receive a control signal from the controlling part 120, and supply a driving current to the corresponding LED 112. Therefore, the LED 112 emits light comprising an intensity proportional to the supplied driving current.

A substrate of the backlight 110 is provided with the plurality of light leading tubes 116 respectively receiving light from the LEDs 112. Each light leading tube 116 transmits the received light to the light sensor 117 as a light transmitting part.

The light sensor 117 is preferably provided on the substrate of the backlight 110 and detects the light transmitted through each light leading tube 116.

The controlling part 120 measures the intensity of the light detected by the light sensor 117. The controlling part 120 may be provided on the substrate of the backlight 110. Alternatively, the controlling part 120 may be provided in other positions.

The storing part 130 stores a reference value for light intensity demanded from the LEDs 112. The reference value may have multiple values classified by output levels of the LEDs 112.

The controlling part 120 compares the intensity of the light emitted from the LED 112 and detected by the light sensor 117 with the reference value stored in the storing part 130, and generates a compensation signal according to the difference. The controlling part 120 then sends the compensation signal to the corresponding current supplying part 113 to be added to the control signal which has already been sent. Accordingly, the current supplying part 113 may receive the control signal added with the compensation signal, and supply an adjusted driving current to the corresponding LED 112. Thus, the LED 112 generates light comprising an intensity adjusted to the reference value.

Then, the controlling part 120 stores information including the compensation signal in the storing part 130. Here, the information including the compensation signal corresponds to information relating to the amount of the driving current which allows the LED 112 to generate light comprising an intensity corresponding to the reference value in a standpoint of the current supplying part 113.

The above adjustment of the light of the LED 112 may be performed to all the LEDs 112 provided to the backlight 110, and consequently, as illustrated in FIG. 2, compensation values di₁₁ to di₃₃ are respectively attached to signal currents i supplied to the current supplying parts 113.

Here, the reference value for the intensity of light stored in the storing part 130 may be set to have a predetermined value in a manufacturing process, or by selection of a user or service personnel.

Alternatively, the reference value may be set to comprise a value corresponding to the intensity of the light generated from one of the plurality of LEDs 112. For example, an LED₂₂ is driven, and then the intensity of light generated from the LED₂₂ is measured through the light sensor 117 and the controlling part 120 to be set as the reference value. Therefore, all the remaining LEDs 112, except the LED₂₂, are adjusted to have a light intensity corresponding to the LED₂₂.

The controlling part 120 stores information about the amount of driving current to be supplied to the corresponding LED 112 from each current supplying part 113 in the storing part 130 so that each LED 112 may emit light comprising the light intensity corresponding to the reference value. Thus, the controlling part 120 controls each current supplying part 113 based on the information stored in the storing part 130, and accordingly the backlight 110 may generate light comprising uniform brightness distribution.

Further, the controlling part 120 may add or subtract information about an operational environment of the display apparatus 100 to or from the control signal. The information about the operational environment may comprise temperature information affecting the light intensity of the LED 112 and an image information input to the display apparatus 100. The temperature information may be obtained through a temperature sensor provided on the LED 112. The temperature information and the image information may comprise a functional relation with the driving of the LED 112.

The adjustment of light of the LED 112 may be performed in the manufacturing process of the display apparatus 100. In the manufacturing process of the display apparatus 100, data comprising information about the amount of driving current to be supplied to the current supplying part 113 for obtaining the uniform brightness distribution of the backlight 110 is stored to the storing part 130. Also, the display apparatus 100 is manufactured without the light leading tube 116 and the light sensor 117, and the controlling part 120 is manufactured without the function for adjusting the amount of driving current of the current supplying part 113.

In the display apparatus 100, to control each current supplying part 113, the controlling part 120 sends the control signal optimally adjusted based on the data stored in the storing part 130 to each current supplying part 112. Therefore, each current supplying part 113 may supply the adjusted driving current to the corresponding LED 112. Consequently, each LED 112 may generate light comprising the uniform light intensity corresponding to the reference value.

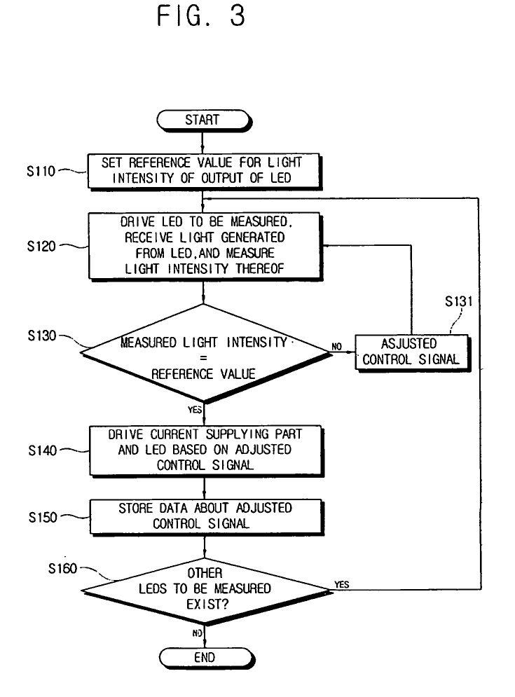

FIG. 3 is a flowchart illustrating a brightness adjusting method for the display apparatus 100 in FIG. 2. Initially, a reference value for the intensity of light demanded from each LED 112 is set (S110). The reference value may be set to have a predetermined selected value, or to have the value corresponding to the intensity of light generated from one LED 112 selected among the plurality of LEDs 112.

The current supplying part 113 is driven for the LED 112 to generate light, and then the intensity of the light generated from the LED 112 is measured (S120).

The measured light intensity and the reference value are compared to each other (S130). If the measured intensity of the light and the reference value are not substantially the same, the adjusted control signal to compensate for the difference between the values is sent (S131) to the LED to be measured and to measure light intensity. According to the comparison result, a control signal adjusted to compensate for the difference between the values is sent to the current supplying part 113 to drive again the LED 112 (S140). After driving the LED 112, the light intensity measured may be compared with the reference value again. If the light intensity and the reference value are different, the control signal adjusted to compensate for the difference between the values may be sent again to the current supplying part 113 to drive the LED 112.

If the measured intensity of the light generated from the LED 112 driven by the adjusted control signal and the reference value are substantially the same, the data relating to the adjusted control signal (such as, the amount of adjusted driving current of the current supplying part 113) is stored (S150).

A determination is then made as to whether other LEDs 112 to be measured exist (S160). If other LEDs 112 to be measured exist, the above steps (S120 to S150) are repeated to the other LEDs 112. If no further LEDs 112 to be measured exist, the brightness adjusting method is completed.

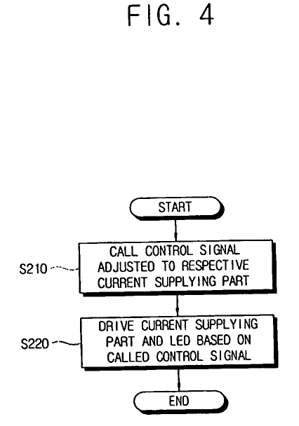

FIG. 4 is a flowchart illustrating a method for accomplishing a uniform brightness distribution for the display apparatus 100 by using the data relating to the control signal generated and stored according to the brightness adjusting method in FIG. 3. Initially, the information relating to the amount of the driving current with respect to each LED 112, that is, the information about the adjusted control signal with respect to each current supplying part 113 is called (S210). Here, the information is provided through the brightness adjusting method in FIG. 3. The information may be called from the storing part 130.

Each current supplying part 113 and the corresponding LED 112 are driven based on the called information (S220). Accordingly, all the LEDs 112 provided to the backlight 110 can generate light comprising the same light intensity, and thus, the backlight 110 can emit light comprising the uniform light distribution over the entire display screen.

The display apparatus and the brightness adjusting method, according to an exemplary embodiment of the present invention, allow all the LEDs provided to the backlight of the display apparatus to generate light comprising the same light intensity, and accordingly can accomplish the uniform brightness distribution over the entire display screen.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A display apparatus comprising:
a backlight comprising a plurality of LEDs and a plurality of current supplying parts respectively for supplying a driving current to the LEDs;
a light sensor for receiving light generated from the LEDs; and
a controlling part for controlling the current supplying parts to selectively drive the LEDs, and for adjusting the amount of the driving current of the current supplying parts to be supplied to the driven LED whereby the intensity of light received to the light sensor corresponds to a reference value.

2. The display apparatus according to claim 1, further comprising a plurality of light transmitting parts for transmitting light generated from each LED to the light sensor,
wherein the LEDs are controlled by the controlling part to respectively supply the light to the corresponding light transmitting part.

3. The display apparatus according to claim 1, wherein the controlling part selects at least one of the LEDs, and sets the intensity of the light generated from a selected LED as the reference value.

4. The display apparatus according to claim 1, further comprising a storing part for storing information relating to the amount of the driving current of the current supplying parts to be supplied to each LED.

5. A display apparatus comprising:
a backlight comprising a plurality of LEDs and a plurality of current supplying parts for supplying a driving current to the LEDs;
a storing part for storing information about the amount of the driving current to be supplied to the LED whereby the intensity of light generated from the LEDs corresponds to a reference value, and
a controlling part for controlling the amount of the driving current of the current supplying parts based on the information stored in the storing part.

6. A brightness adjusting method for a display apparatus comprising a backlight comprising a plurality of LEDs and a plurality of current supplying parts supplying a driving current to the LEDs, comprising:
setting a reference value for the intensity of light;
receiving light generated from the LEDs selectively driven by controlling the current supplying parts; and
adjusting the amount of the driving current of the current supplying parts whereby the intensity of the received light corresponds to the reference value.

7. The brightness adjusting method according to claim 6, wherein the reference value setting stage comprises:
selecting at least one of the LEDs, and
setting the intensity of light generated from a selected LED as the reference value.

8. The brightness adjusting method according to claim 6, further comprising storing information about the amount of the driving current of the current supplying parts to be supplied to each LED.

9. A brightness performing method for a display apparatus comprising a backlight comprising a plurality of LEDs and a plurality of current supplying parts respectively supplying a driving current to the LEDs, comprising:
providing information about the amount of the driving current to be supplied to each LED whereby the intensity of light generated from the LEDs corresponds to a reference value; and
adjusting the amount of the driving current of the current supplying parts based on the provided information.
